(19) United States
(12) Patent Application Publication
(10) Pub. No.: US 2004/0258789 A1
(43) Pub. Date: Dec. 23, 2004

(54) Tube bending apparatus and method

(76) Inventors: James D. Phillips, Posen, MI (US); Alan Smolinski, Hubbard Lake, MI (US)

Correspondence Address: REISING, ETHINGTON, BARNES, KISSELLE, P.C., P O BOX 4390, TROY, MI, 48099-4390, US

(21) Appl. No.: 10/850,543

(22) Filed: May 20, 2004

Related U.S. Application Data
(60) Provisional application No. 60/479,736, filed on Jun. 19, 2003.

(51) Int. Cl. A23P 1/00

(52) U.S. Cl. 425/384

(57) ABSTRACT

A method and apparatus for bending a plastic tube using heated dies. The tube is cooled after release from the dies and takes a set. A spring may be inserted in the tube to support the tube while it is being bent.

### REFERENCE TO RELATED APPLICATION

This application is based on U.S. Provisional application 60/479,736 filed Jun. 19, 2003.

### FIELD OF INVENTION

This invention relates to an apparatus and method for bending tubing, and more particularly, for bending plastic tubing while it is in a heated, pliable state, after which it is cooled to take a set and retain the desired shape.

### BACKGROUND OF THE INVENTION

It is known that a precut plastic tube can be bent over a sheet of aluminum and held in place with clips. The entire assembly, including the sheet of aluminum, the clips and the tube, is heated in an oven for 12-20 minutes to a temperature which makes the plastic tube pliable. The tube is then cooled by immersing it in water for 3-6 minutes. The tube will retain the approximate shape of the bend. This process can take up to 26 minutes and is a manual operation. The tube does not exactly duplicate the bend it was in while clipped to the aluminum sheet and therefore, trial and error is needed to get the desired shape. This process is not exact and is very expensive. It is not exact because the tube is supported on an aluminum sheet with clips on one side only. The opposite side of the tube is unsupported.

Another method presently in use involves bending the plastic tube around pulleys that are of the desired radius, and positioned so that the tube will assume a desired shape, with the straight sections of the tube unsupported. Only those portions of the tube where the bend or radius is required should be heated because this is the only part of the tube that is supported.

Most of these present methods leave a major portion of the tube unsupported and thus the unsupported portion is movable in an uncontrolled manner, making it difficult to predict the final results.

### SUMMARY OF THE INVENTION

In accordance with the present invention, apparatus is provided preferably comprising a pair of dies that may be machined from solid blocks of aluminum. The dies are milled to the desired shape of the tube to be bent, and preferably have built-in heaters to keep the temperature of the dies constant. The dies have complementary grooved surfaces providing grooves which are semi-circular in cross-section and cooperate to form a channel of circular cross-section to grip the tube around a full 360° of its circumference. The tube is thus supported on all sides for the portion of its length in the bend area. Complicated or extra long tubes may require more than one set of dies.

Only the bend area of the tube is heated. It is possible to accurately control the final shape. Also, because the tube is cooled while it is still between the dies or at least partially between the dies, the resulting shape of the tube after removing it from the dies is predictable and very accurate. Trial and error tests are not necessary.

Cooling of the tube after it is heated between the dies is accomplished fairly rapidly and requires no more than about 8 seconds to cool it sufficiently. The whole process usually requires less than 30 seconds. This operation can be fully automatic and does not require an operator except for initial set up. Preferably, the cooling of the tube after heating is carried out while the dies are at least partially open so that very little cooling of the dies occurs when the tube is cooled. This results in a considerable energy savings.

Because the dies are internally heated, they remain always at the desired temperature. Although tube bending can be carried out with dies that are not internally heated, such dies have to be removed from time-to-time and re-heated in an oven, adding to the over-all time required to complete a series of tube bending operations.

One object of this invention, is to provide an apparatus and method for bending tubes having the foregoing features and capabilities.

Other objects, features and advantages of the invention will become more apparent as the following description proceeds, especially when considered with the accompanying drawings.

### BRIEF DESCRIPTION OF THE DRAWINGS

FIG. 1 is a plan view of apparatus for bending tubing, constructed in accordance with the invention;

FIG. 2 is a diagrammatic view showing parts of the apparatus in a load, cut-off position;

FIG. 3 is a diagrammatic view showing parts of the apparatus in a forming position;

FIG. 4 is a diagrammatic view showing parts of the apparatus in a cooling position;

FIG. 5 is a diagrammatic view showing parts of the apparatus in an unload position;

FIG. 6 is a plan view of apparatus of a modified construction, but also constructed in accordance with the invention. The apparatus is shown in a pre-load position;

FIG. 7 is a diagrammatic view showing parts of the apparatus in a load position;

FIG. 8 is a diagrammatic view showing parts of the apparatus in a cut-off position;

FIG. 9 is a diagrammatic view showing parts of the apparatus in a pre-form clamp position;

FIG. 10 is a diagrammatic view showing parts of the apparatus in a spring retract and forming position;

FIG. 11 is a diagrammatic view showing parts of the apparatus in a cooling position; and

FIG. 12 is a diagrammatic view showing parts of the apparatus in an unload position.

### DETAILED DESCRIPTION OF THE PREFERRED EMBODIMENTS

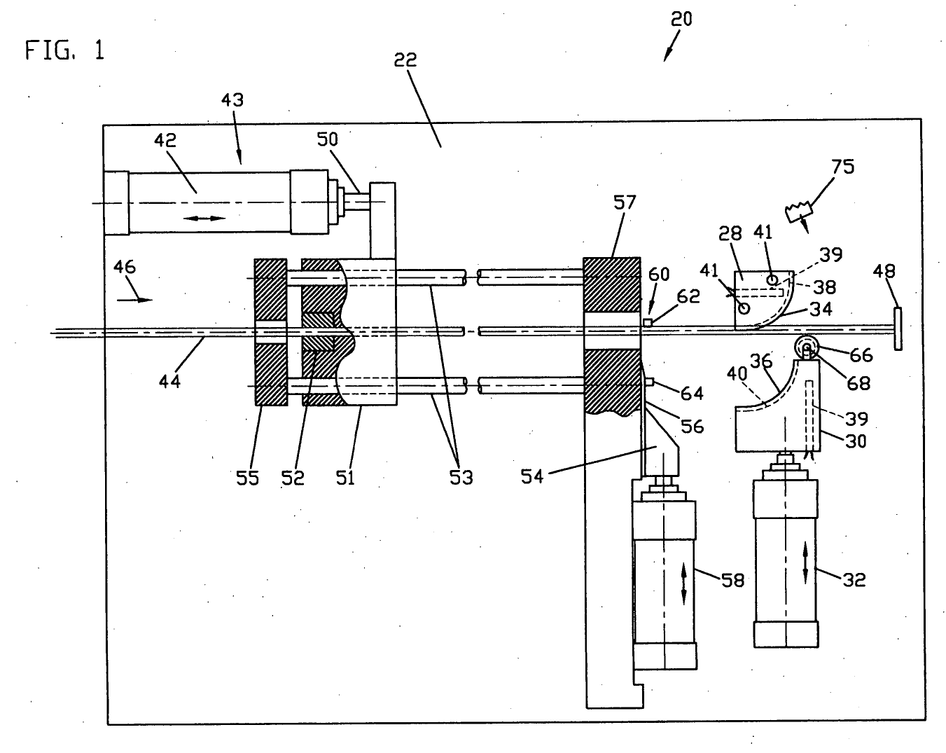

Referring now more particularly to the drawings and especially to FIGS. 1-5, the apparatus of this invention is generally designated by the numeral 20 and comprises a base 22 on which are mounted a heated stationary die 28 and a heated movable die 30, both preferably made of aluminum.

The movable die 30 is capable of being moved toward and way from the stationary die 28 between closed and open positions by an actuator 32 shown here as being in the form of a piston-cylinder assembly. The dies have complementary curved and grooved surfaces including a convex grooved surface 34 on the stationary die and a concave grooved surface 36 on the movable die. The grooves 38 and 40 in the respective surfaces 34 and 36 are semi-circular in cross-section and cooperate to form a channel of circular cross-section to receive and grip a tube T that is to be formed between the dies. Together, the grooves 38 and 40 grip the tube T around a full 360° of its circumference when the dies are closed. The tube T is preferably made of a suitable thermoplastic material such as polyethylene. The dies have internal heating elements 39 for maintaining them at the desired temperature. The die 28 may be releasably secured to the base top by fasteners 41 and the die 30 may be releasably secured to the actuator 32 so that they may be removed for repair or replacement. Should the heating elements fail, the dies may be placed in an oven and heated to an appropriate temperature to facilitate tube bending.

A feeder 43 is provided for advancing a length of tubing or tube stock 44 in the direction of the arrow 46 through a space between the dies when the movable die is retracted, and against a fixed tube stop 48. The feeder 43 comprises an actuator 42 that has a piston rod 50 connected to a tube driver 51 which has a gripper 52 that grips or releases the length of tubing 44 on command. The gripper 52 is slidable toward and away from the dies 28 and 30 on rails 53. The ends of the rails 53 are anchored in fixtures 55 and 57.

A tube cut-off 54 has a knife 56. The tube cut-off 54 is actuated by an actuator 58 here shown as being in the form of a piston-cylinder assembly to advance the tube cut-off and cause the knife to sever the tube T from the length of tubing 44. A clamp 60 has a fixed jaw 62 and a jaw 64 mounted on the knife 56 which cooperates with the fixed jaw 62 to clamp the tube T when the knife 56 is advanced to cut off the tube. The knife 56 slides along the fixture 57.

The tube T adapted to be formed in this apparatus may be of a suitable outside diameter, as for example 3/16″ of an inch.

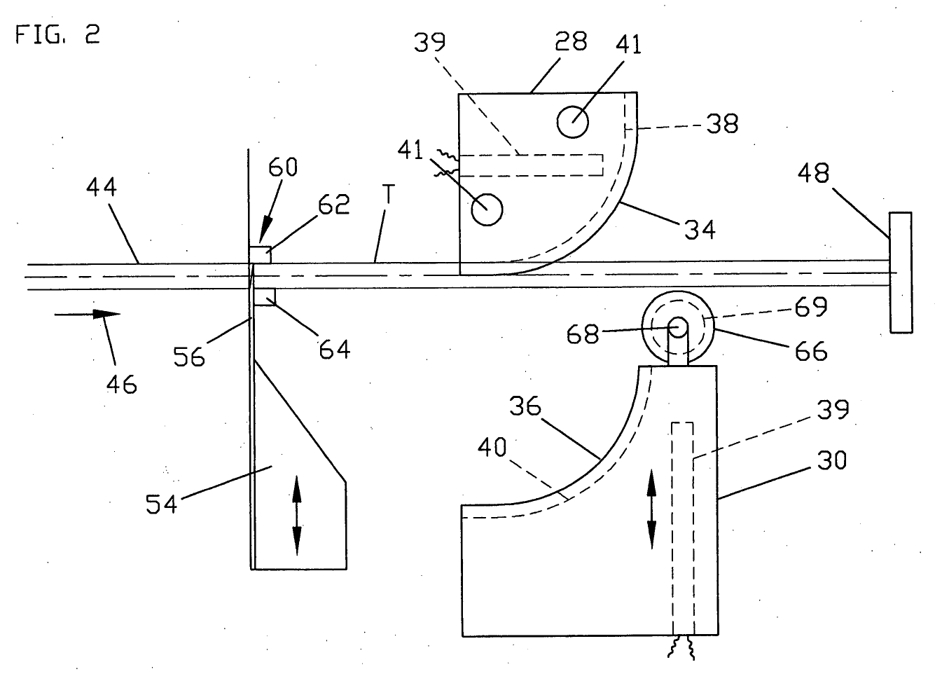

In carrying out the tube bending process, the dies 28 and 30 are heated to a temperature sufficient to make the tube pliable. Assuming the tube T is made of a suitable thermo-plastic material such as polyethylene, it will be heated to a temperature of about 150° to 350° Fahrenheit. The temperature to which the tube is heated will depend on the material of which the tube is made. The actuator 42 feeds a length of the tubing 44 against the tube stop 48 as shown in FIGS. 1 and 2, after which the actuator 58 advances the tube cut-off 54 to move the knife 56 across the path of the advanced tubing to cut off the tube T. The jaw 64 cooperates with the jaw 62 to clamp the cut end of the tube T when the knife is advanced to cut off the tube. At this time, the heated movable die 30 is in the open position shown in FIGS. 1 and 2.

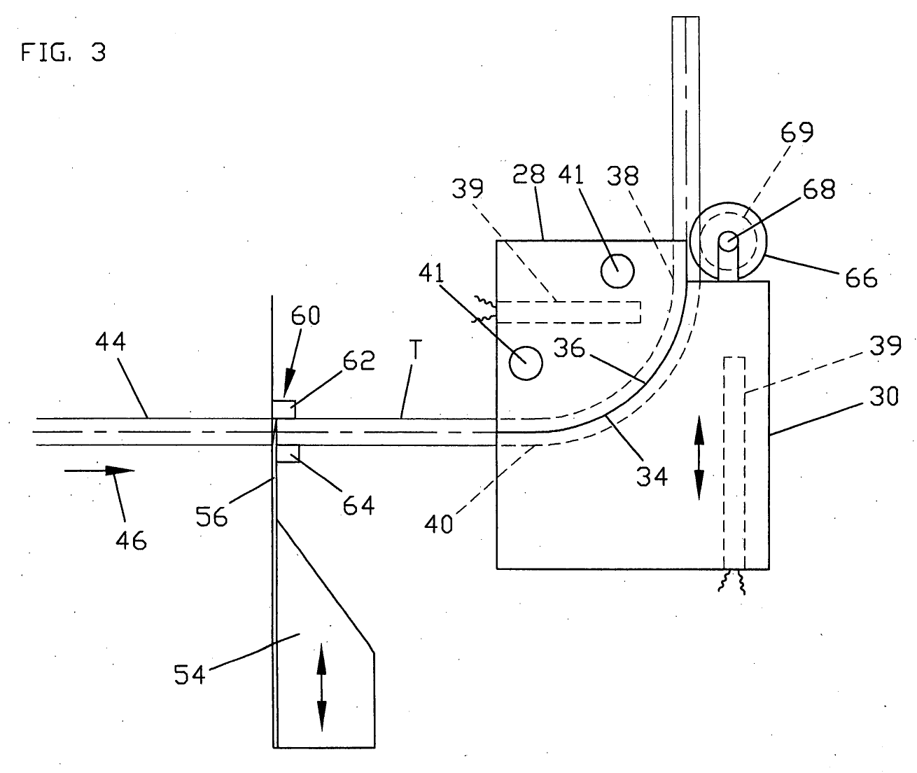

Thereafter, the movable die 30 is advanced by the actuator 32 to the closed position shown in FIG. 3 in which the grooves 38 and 40 of the curved surfaces 34 and 36 of the dies cooperate to form a channel of circular cross-section in which the tube T is tightly gripped and bent to the position shown. The tube T is gripped around 360° of its circumference by the grooves 38 and 40. The jaws 62 and 64 hold the tube T while the movable die 30 advances so that the tube does not kick back toward the knife 56 when die 30 contacts the tube. A roller guide 66 is preferably mounted on the movable die 30 by a pivot pin 68 to initially engage the tube T as the movable die 30 advances, and wrap the tube T around the curved portion of the stationary die 28. The roller guide has an annular groove 69 in which the tube T fits when the roller guide engages the tube. The dies 28 and 30 will remain closed for a brief period of time sufficient to heat the tube T, and make it soft and pliable enough to take a permanent set in the bent condition.

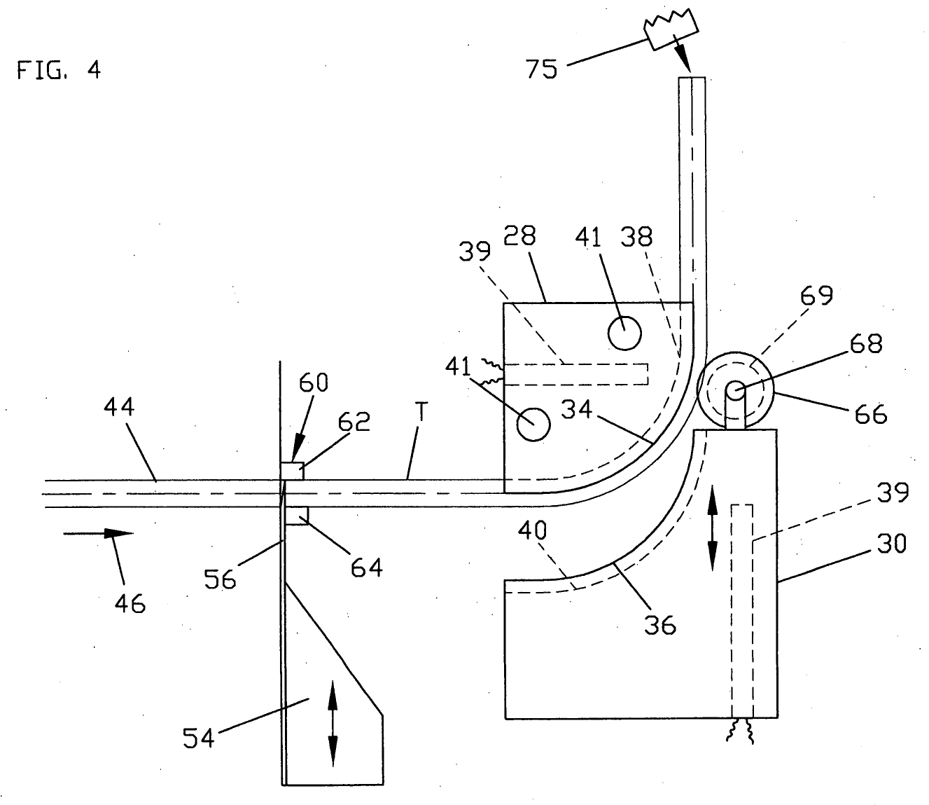

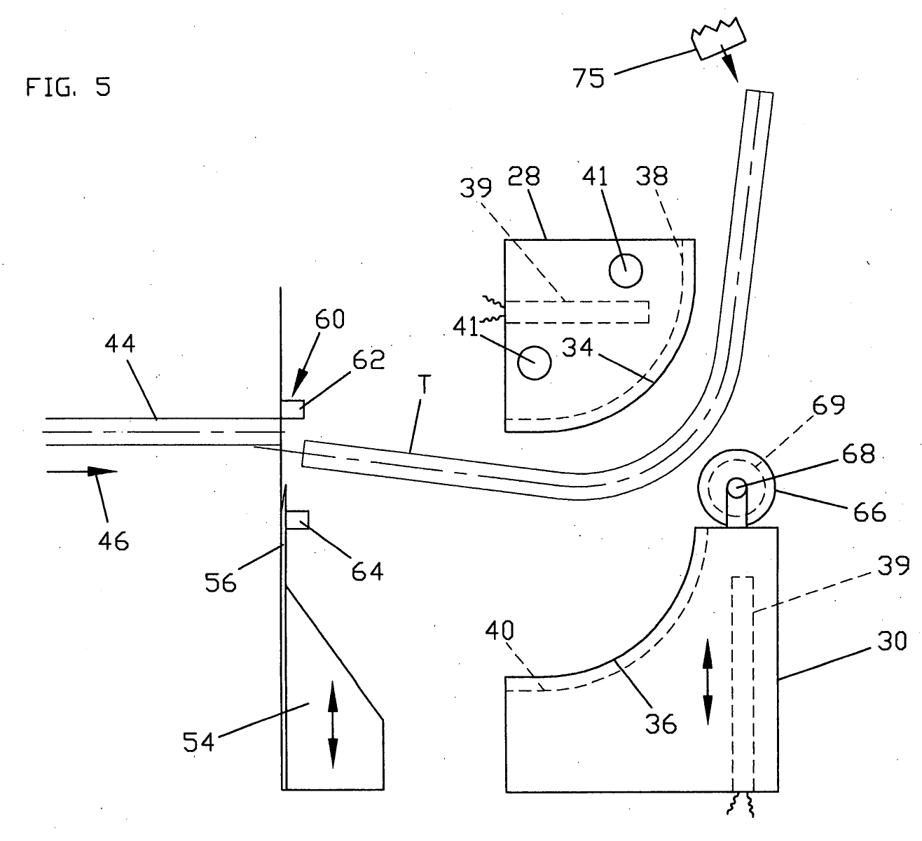

Thereafter, the die 30 is partially retracted so that the tube T is only loosely held between the dies 28 and 30 (FIG. 4). A blast of air from a blower 75 is then forced through the tube and over the outside of the tube to cool it and cause it to take a permanent set in the form shown. The blower 75 is actuated manually or by automatic control when the movable die 30 is partially retracted to the FIG. 4 position. Thereafter, the movable die is completely retracted as shown in the unload position of FIG. 5 while the blast of air continues, thus continuing to cool the tube T and also to blow it out of the dies and into a suitable receptacle or conveyor to carry the tube away. The overall time for carrying out the bending operation is probably less than 30 seconds.

After a cut-off length of tubing is formed as described, the process may be repeated by advancing a further length of the tubing 44 up against the stop 48. The dies, if internally heated, remain in a heated condition. If not internally heated, the dies may need to be removed and placed in an oven to bring them up to a suitable tube-bending temperature before repeating the process.

The dies are preferably heated or maintained at a suitable temperature to make the plastic tube sufficiently pliable for forming into a bend. If the tube is made of polyethylene, the dies are preferably heated to a temperature between 150° Fahrenheit and 350° Fahrenheit. Heating the dies in an oven requires several minutes and can be avoided if the dies are internally heated. Cooling the tube after the dies are open can be accomplished in approximately eight seconds to bring the temperature below the minimum softening temperature.

If the dies are heated in an oven, only a relatively small oven is required. Also, because the entire cooling of the tube T takes place while the dies are open or at least partially open, the blast of air has little or no cooling effect on the dies. Only the tube T is cooled by the blast of air.

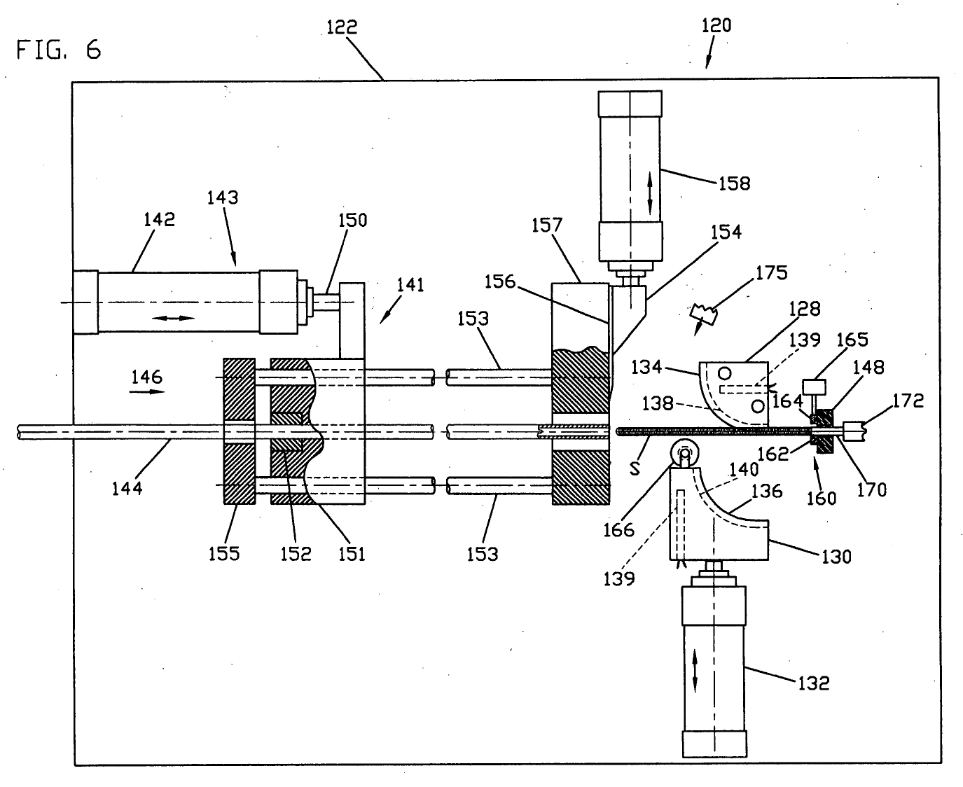

Referring now to FIGS. 6-12, apparatus of a modified construction is shown and generally designated by the numeral 120. The apparatus 120 comprises a base 122 on which are mounted a heated stationary die 128 and a heated movable die 130, both preferably made of aluminum. The movable die 130 is capable of being moved toward and away from the stationary die 128 by an actuator 132 which is here shown as a piston-cylinder assembly. The dies have complementary curved and grooved surfaces including a convex grooved surface 134 on the stationary die and a concave grooved surface 136 on the movable die. The grooves 138 and 140 in the respective surfaces 134 and 136 are semi-circular in cross-section and cooperate to form a channel of circular cross-section to receive and grip a tube TT to be formed between the dies. Together, the grooves 138 and 140 grip the tube TT around a full 360° of its circumference when the dies are closed. The tube TT is of a material similar to the material of the tube T. The dies have internal heating elements 139 for maintaining them at the desired temperature. The dies may be removable for repair or replacement. Should the heating elements fail, the dies may be removed and placed in an oven and heated to an appropriate temperature to facilitate bending. The die temperature may be the same as in the first embodiment.

A feeder 143 is provided for advancing a length of tubing or tube stock 144 in the direction of the arrow 146 through a space between the dies against a fixed stop 148 while the movable die is retracted. The feeder 143 comprises an actuator 142 that has a piston rod 150 connected to a tube driver 151 which has a gripper 152 that grips or releases the length of tubing 144 on command. The driver 151 is slidable toward and away from the dies 128 and 130 on rails 153. The ends of the rails 153 are anchored in fixtures 155 and 157. A tube cut-off 154 has a knife 156 and is actuated by an actuator 158 in the form of a piston-cylinder assembly to advance the tube cut-off and cause the knife to sever the tube TT from the length of tubing 144. The knife 156 slides along the fixture 157. A clamp 160 has a fixed jaw 162 and a jaw 164 movable from a retracted position to an advanced position by an actuator 165 where it cooperates with the jaw 162 to clamp the tube.

The tube TT formed in this machine is of larger diameter than the tube T and may, for example, have an outside diameter of ⅝″.

In larger diameter tubing, it is desirable to use an internal support member, preferably a spring, to internally support the tube, the spring being shown in this embodiment as an elongated coil spring S of approximately the same length as the severed tube TT. The spring prevents the tube TT from flattening into an oval cross-section at the bend when bent by the dies. The spring S has one end secured to a rod 170 extending from the piston (not shown) of an actuator 172 which may be in the form of a piston-cylinder assembly. The actuator 172 is provided to advance the spring S to a position between the open dies through an opening in the stop 148 and to retract the spring after the dies have partially closed.

FIGS. 6-12 show the sequence of operation of the apparatus in carrying out the process of tube bending. As in the previous embodiment, the dies are initially heated to a temperature sufficient to make the tubing pliable and bendable, and this temperature may be the same as that set forth in the description of the process first described. Again, the dies may be initially heated in an oven or they may be internally heated, and maintained at the desired temperature during the tube bending.

FIG. 6 shows a pre-load position in which the length of tubing 144 has been advanced by the actuator 142 to a position adjacent the tube cut-off 154 and the spring S has been advanced by the actuator 172 into a space between the two dies in alignment with the tubing, while the movable die is in the retracted position.

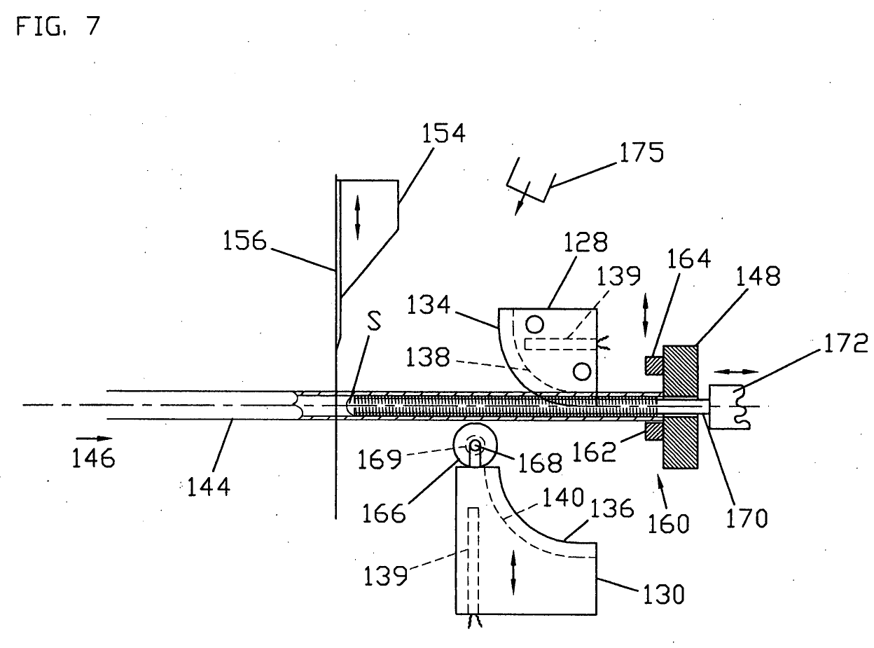

FIG. 7 shows the load position in which the length of tubing has been advanced between the dies over the spring S and against the stop 148.

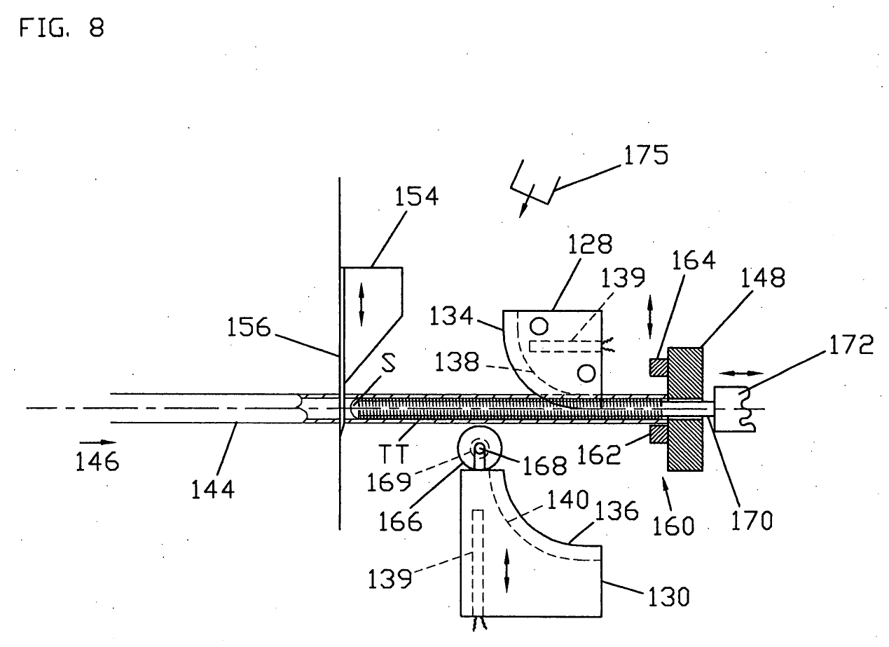

FIG. 8 shows the cut-off position in which the knife 156 of the tube cut-off 154 has been advanced by the actuator 158 far enough to sever the tube TT from the length of tubing. At this point in the process, the movable die remains in its retracted position.

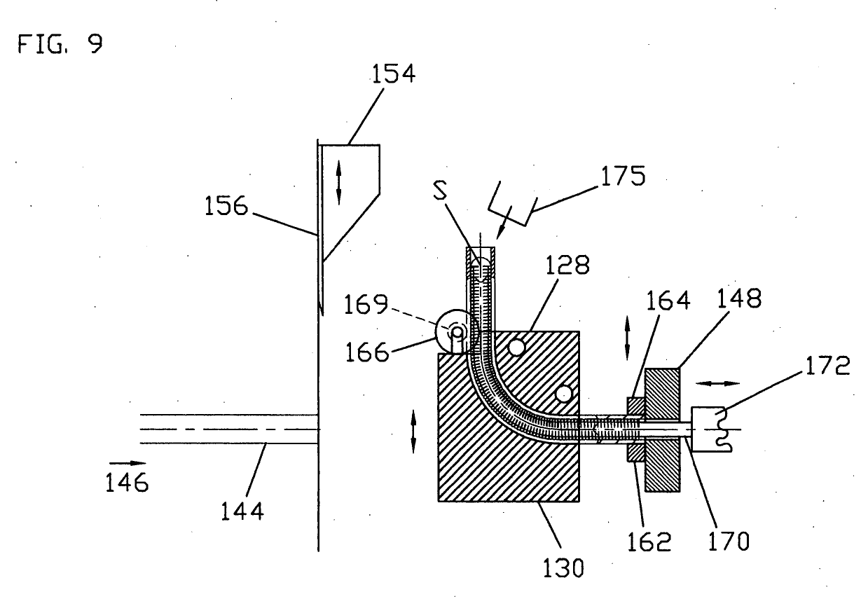

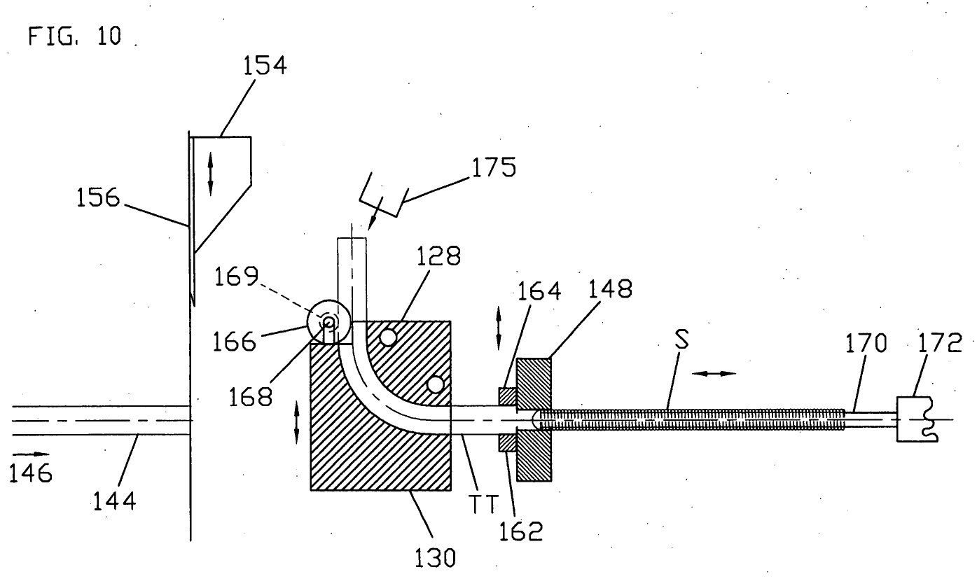

FIG. 9 shows the pre-form clamp position in which the tube cut-off 154 has been retracted, the jaw 164 is advanced by the actuator 165 to cooperate with the jaw 162 to clamp the tube, and the movable die has been advanced by the actuator 132 to the pre-form position, which is slightly less than the fully advanced position so that the tube is bent but is not gripped so tightly that the spring cannot be retracted. The jaws 162 and 164 hold the tube TT while the movable die 130 advances. A roller guide 166 pivoted on the movable die 130 by a pivot pin 168 has a tube-engaging annular groove 169 and serves the same purpose as the guide 66 in the first embodiment. The spring S is retracted by the actuator 172, after which the die 130 advances further to the fully closed forming position shown in FIG. 10. The movable die remains in its fully closed position while the tube TT is completely heated. The spring S has been retracted prior to full closing of the dies so that the spring is not heated in the forming position of FIG. 10.

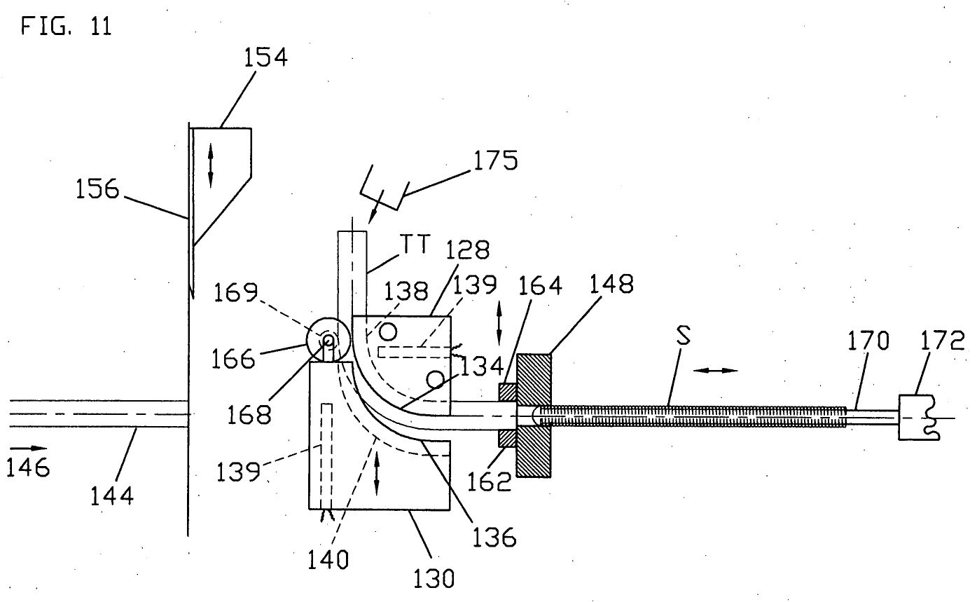

After the tube is heated for a sufficient period of time, the movable die 130 is only partially retracted by the actuator 132 so that the tube is still being held in place by the front edge of the movable die (FIG. 11). During this time, air from a blower 175 is blown through and around the tube, cooling it enough to cause it to retain its shape. The tube TT is only loosely held by the dies so that the air, although it flows through the tube and along the outside of the tube, does not have an appreciable cooling effect on the dies.

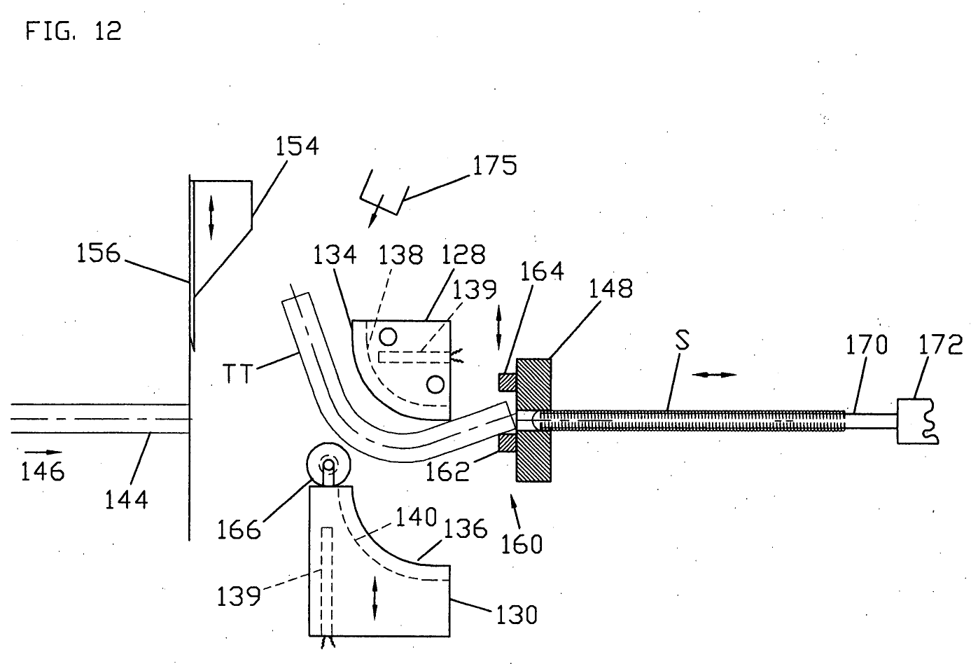

Thereafter, and shown in FIG. 12, the movable die is fully retracted by the actuator 132, the clamp 160 releases the tube TT, and air continues to blow to further cool the tube TT while blowing it out of the space between the dies and into a suitable receptacle or a conveyor for carrying it away.

The time to complete the tube bending operation employing the machine of FIGS. 6-12 is about the same as for the first embodiment although possibly slightly longer because of the use of the spring S.

We claim:

1. A method of bending a plastic tube, comprising:
holding at least a portion of the tube in a desired bent condition while supporting said portion of the tube on all sides thereof,
heating said portion of the tube while continuing to hold said portion of the tube in the bent condition and to support said portion of the tube on all sides to a temperature and for a period of time sufficient to render said portion of the tube pliable enough to take a permanent set in said bent condition,
cooling said portion of the tube while at least loosely holding said portion of the tube in said bent condition for a time sufficient to cause said portion of the tube to take a permanent set, and
thereafter releasing said portion of the tube.

2. The method of claim 1, further including internally supporting said portion of the tube while said portion of the tube is held and supported in the bent condition and heated.

3. The method of claim 2, wherein said portion of the tube is internally supported by a coil spring inserted in said portion of the tube.

4. The method of claim 1, wherein said portion of said tube is held in the desired bent condition by relatively movable dies, said dies having confronting, complementary grooved surfaces provided with grooves which, when the dies are closed, receive and grip the portion of the tube around substantially 360° of its circumference for the afore-mentioned support of said portion of the tube on all sides.

5. The method of claim 4, wherein said dies are partially opened during the cooling of said portion of the tube, and said dies are opened further during the release of said portion of the tube.

6. The method of claim 5, further including internally supporting said portion of the tube while said portion of the tube is held and supported in the bent condition and heated.

7. The method of claim 6, wherein said portion of the tube is internally supported by a coil spring inserted in said portion of the tube.

8. The method of claim 7, wherein the tube is made of thermoplastic material.

9. The method of claim 8, wherein the temperature to which said portion of the tube is heated is between about 150° F. and 350° F.

10. The method of claim 9, wherein said dies are partially opened during the cooling of said portion of the tube, and said dies are opened further during the release of said portion of the tube.

11. Apparatus for bending a plastic tube comprising:
heated first and second dies,
an actuator for relatively moving said dies toward one another to a closed position and away from one another to an open position,
said dies having confronting, complimentary, grooved surfaces provided with grooves which, when the dies are in the closed position are adapted to receive and grip a portion of the tube on all sides thereof and hold said portion of the tube in a desired bent condition for a predetermined period of time such that said portion of the tube is heated sufficiently to become pliable enough to take a permanent set in the bent condition, and
a cooler for directing cooling air over the portion of the tube after the dies are relatively moved by said actuator at least to a partially open position following the expiration of said predetermined period of time.

12. The apparatus of claim 11, wherein said dies have internal heating elements.

13. The apparatus of claim 12, wherein said grooves are each semi-circular in cross-section and, in the closed position of said dies, cooperate to form a tube-receiving channel of circular cross-section.

14. The apparatus of claim 13, wherein said first die has a tube guide engageable with said portion of the tube during relative movement of said dies to the closed position, to assist in bending the said portion of the tube over the second die.

15. The apparatus claim 14, wherein said tube guide comprises a roller rotatably mounted on said first die.

16. The apparatus of claim 13, further including a feeder for feeding tube stock between the dies against a tube stop when the dies are in the open position, and a cutter for cutting off the tube from said tube stock.

17. The apparatus of claim 13, further including an internal support member adapted to be inserted in said portion of the tube prior to relatively moving said dies to the closed position to internally support said portion of the tube when the dies are relatively moved to the closed position.

18. The apparatus of claim 17, wherein said internal support member comprises a coil spring.

19. The apparatus of claim 18, further including a second actuator for inserting said coil spring into said portion of the tube.

20. The apparatus of claim 19, wherein said first die has a tube guide engageable with said portion of the tube during relative movement of the dies to the closed position, to facilitate bending of said portion of the tube, said tube guide comprising a roller rotatably mounted on said first die.
